(19) United States
(12) Patent Application Publication
(10) Pub. No.: US 2026/0163663 A1
(43) Pub. Date: Jun. 11, 2026

(54) LOW-LATENCY SYNCHRONOUS CLOCK AND DATA TRANSMISSION METHOD

(71) Applicant: NOREL SYSTEMS LIMITED, Tianjin (CN)

(72) Inventors: Ke LIANG, Tianjin (CN); Yuanlong Wang, Tianjin (CN)

(21) Appl. No.: 19/467,966

(22) Filed: Feb. 3, 2026

Related U.S. Application Data
(63) Continuation of application No. PCT/CN2024/095155, filed on May 24, 2024.

(30) Foreign Application Priority Data
Aug. 3, 2023 (CN) 202310970962.9

(51) Int. Cl. H04J 3/06; H04L 69/22

(52) U.S. Cl. CPC H04J 3/0658; H04L 69/22

(57) ABSTRACT

Disclosed in the present invention are a low-latency synchronous clock and data transmission method, used for a transmission terminal to transmit a synchronous clock and data with low latency. The transmission terminal receives an incoming synchronization header, which comprises preamble A and preamble B. After detecting preamble A, the transmission terminal starts sending an outgoing synchronization header and continues to detect preamble B. If the transmission terminal detects both preamble A and preamble B, the sent outgoing synchronization header is a first-type outgoing synchronization header; if the transmission terminal detects preamble A but not preamble B, the sent outgoing synchronization header is a second-type outgoing synchronization header. The first-type outgoing synchronization header is different from the second-type outgoing synchronization header.

### CROSS REFERENCE TO RELATED APPLICATION

This application is a continuation application of International Patent Application No. PCT/CN2024/095155, filed on May 24, 2024, which itself claims priority to and benefit of Chinese Patent Application No. 202310970962.9 filed on Aug. 3, 2023 in the State Intellectual Property Office of P. R. China. The disclosure of each of the above applications is incorporated herein by reference in its entirety.

### TECHNICAL FIELD

The present invention relates to the field of communication technologies, and in particular to a low-latency synchronous clock and data transmission method.

### BACKGROUND ART

In common vehicle-mounted audio transmission systems, time-division transmission is often used to transmit audio data. Each time slot transmits one or more audio sampling points, and the system does not transmit data between time slots. Therefore, the clock recovery circuit cannot rely on continuous data transmission. For clock recovery, the transmitting end may add a segment of special characters as a synchronization header before the data of a time slot. After receiving the synchronization header, the receiving end can use the position of the synchronization header to perform clock recovery and generate a local clock. The position of the synchronization header refers to the time when the receiving end receives and identifies the synchronization header. After receiving and identifying the synchronization header, synchronization header position information is generated, and this information is sent to a phase-locked loop (PLL) circuit to recover and generate a local clock.

In vehicle-mounted audio transmission systems, to save wires, a multi-level topology is often used to connect each node. When the node cascading depth is large, to prevent the delay of the last-level node receiving the synchronization header relative to the first-level node sending the synchronization header from being excessively large, the delay from each node starting to receive the synchronization header from the previous-level node to starting to send the synchronization header to the next-level node should be kept low.

To keep the delay from each node starting to receive the synchronization header from the previous-level node to starting to send the synchronization header to the next-level node low, a method of reducing the length of the synchronization header bit sequence can usually be adopted. However, this method is prone to false detection of the synchronization header during the period when no data is transmitted between time slots due to noise interference on the channel, or incorrect judgment of the synchronization header position, thereby increasing the false detection rate of the synchronization header.

Currently, there is a lack of a method that can recover the clock through the position of the received synchronization header, maintain a small delay from starting to receive the synchronization header from the previous-level node to starting to send the synchronization header to the next-level node, and at the same time maintain a low false detection rate of the synchronization header.

### SUMMARY

The technical problem to be solved by the present invention is how to recover the clock through the position of the received synchronization header, maintain a small delay from starting to receive the synchronization header from the previous-level node to starting to send the synchronization header to the next-level node, and at the same time maintain a low false detection rate of the synchronization header.

To solve the above technical problem, the technical solution adopted by the present invention is as follows:
As a low-latency synchronous clock transmission method of the present invention, used for a transmission terminal to transmit a synchronous clock with low latency, the transmission terminal receives an incoming synchronization header, which comprises preamble A and preamble B. After detecting preamble A, the transmission terminal starts sending an outgoing synchronization header and continues to detect preamble B. If the transmission terminal detects both preamble A and preamble B, the sent outgoing synchronization header is a first-type outgoing synchronization header; if the transmission terminal detects preamble A but not preamble B, the sent outgoing synchronization header is a second-type outgoing synchronization header. The first-type outgoing synchronization header is different from the second-type outgoing synchronization header.
Preferably, if the transmission terminal detects both preamble A and preamble B, the transmission terminal uses the position of the incoming synchronization header to perform clock recovery and generate a local clock.
Preferably, if the transmission terminal fails to detect preamble B after detecting preamble A, the transmission terminal discards the incoming synchronization header.
Preferably, if a terminal receiving the outgoing synchronization header receives the first-type outgoing synchronization header, the terminal uses the position of the outgoing synchronization header to perform clock recovery and generate a local clock.
Preferably, if a terminal receiving the outgoing synchronization header receives the second-type outgoing synchronization header, the terminal discards the outgoing synchronization header.
Preferably, the time interval of the incoming synchronization header is a preset value T1, the time interval of the outgoing synchronization header is a preset value T2, and T1 is equal to T2.
Further, the transmission terminal sends the outgoing synchronization header using the generated local clock.
Preferably, the method for the transmission terminal to detect preamble A is: if there exists a continuous N0-bit subsequence SA in preamble A such that the Hamming distance between SA and a preset N0-bit codeword PA is less than a preset value N1, then the transmission terminal detects preamble A.
Preferably, the method for the transmission terminal to detect preamble B is: if the Hamming distance between preamble B and a preset codeword PB is less than a preset value N2, then the transmission terminal detects preamble B.
Preferably, the transmission terminal is implemented as an integrated circuit chip.
As a low-latency data transmission method of the present invention, used for a transmission terminal to transmit data with low latency, the transmission terminal receives an incoming synchronization header and a data field following the incoming synchronization header. The transmission terminal uses the incoming synchronization header to determine the position of the data field, and the data field is used for transmitting data. The incoming synchronization header comprises preamble C and preamble D. After detecting preamble C, the transmission terminal starts sending an outgoing synchronization header and continues to detect preamble D. If the transmission terminal detects both preamble C and preamble D, the sent outgoing synchronization header is a third-type outgoing synchronization header, and the transmission terminal sends the data field after sending the third-type outgoing synchronization header; if the transmission terminal detects preamble C but not preamble D, the sent outgoing synchronization header is a fourth-type outgoing synchronization header. The third-type outgoing synchronization header is different from the fourth-type outgoing synchronization header.
Preferably, if the transmission terminal fails to detect preamble D after detecting preamble C, the transmission terminal discards the incoming synchronization header and the data field following the incoming synchronization header.
Preferably, if a terminal receiving the outgoing synchronization header receives the fourth-type outgoing synchronization header, the terminal discards the outgoing synchronization header.
Preferably, the method for the transmission terminal to detect preamble C is: if there exists a continuous N3-bit subsequence SC in preamble C such that the Hamming distance between SC and a preset N3-bit codeword PC is less than a preset value N4, then the transmission terminal detects preamble C.
Preferably, the method for the transmission terminal to detect preamble D is: if the Hamming distance between preamble D and a preset codeword PD is less than a preset value N5, then the transmission terminal detects preamble D.
Preferably, the transmission terminal is implemented as an integrated circuit chip.

### BRIEF DESCRIPTION OF DRAWINGS

FIG. 1 is a block diagram of a transmission system for a low-latency synchronous clock transmission method according to the present invention;

FIG. 2 is a structural diagram of an incoming synchronization header and an outgoing synchronization header in a low-latency synchronous clock transmission method according to the present invention;

FIG. 3 is a schematic diagram of a transmission terminal receiving a complete incoming synchronization header and sending a first-type outgoing synchronization header in a low-latency synchronous clock transmission method according to the present invention;

FIG. 4 is a schematic diagram of a transmission terminal not receiving a complete incoming synchronization header and sending a second-type outgoing synchronization header in a low-latency synchronous clock transmission method according to the present invention;

FIG. 5 is a schematic diagram of the first several bits of preamble A′ and preamble A″ being the same when a transmission terminal sends a first-type outgoing synchronization header and a second-type outgoing synchronization header respectively after receiving an incoming synchronization header in a low-latency synchronous clock transmission method according to the present invention;

FIG. 6 is a schematic diagram of an upstream transmission terminal sending an incoming synchronization header and a transmission terminal sending an outgoing synchronization header in a low-latency synchronous clock transmission method according to the present invention;

FIG. 7 is a schematic diagram of the position of an incoming synchronization header in a low-latency synchronous clock transmission method according to the present invention;

FIG. 8 is a schematic diagram of the position of a first-type outgoing synchronization header in a low-latency synchronous clock transmission method according to the present invention;

FIG. 9 is an example of preamble A and its subsequences in a low-latency synchronous clock transmission method according to the present invention;

FIG. 10 is an example of preamble A containing 2-bit errors and its subsequences in a low-latency synchronous clock transmission method according to the present invention;

FIG. 11 is a structural diagram of an incoming synchronization header, a data field, an outgoing synchronization header, and a data field in a low-latency data transmission method according to the present invention;

FIG. 12 is a schematic diagram of a transmission terminal receiving a complete incoming synchronization header and data field, and sending a third-type outgoing synchronization header and data field in a low-latency data transmission method according to the present invention;

FIG. 13 is a schematic diagram of a transmission terminal not receiving a complete incoming synchronization header and sending a fourth-type outgoing synchronization header in a low-latency data transmission method according to the present invention;

FIG. 14 is a schematic diagram of the first several bits of preamble C′ and preamble C″ being the same when a transmission terminal sends a third-type outgoing synchronization header, a data field, and a fourth-type outgoing synchronization header respectively after receiving an incoming synchronization header in a low-latency data transmission method according to the present invention;

FIG. 15 is another two structural diagrams of a second-type outgoing synchronization header in a low-latency synchronous clock transmission method according to the present invention;

FIG. 16 is a schematic diagram of a transmission terminal not receiving a complete incoming synchronization header and sending another second-type outgoing synchronization header in a low-latency synchronous clock transmission method according to the present invention;

FIG. 17 is a schematic diagram of a transmission terminal not receiving a complete incoming synchronization header and sending yet another second-type outgoing synchronization header in a low-latency synchronous clock transmission method according to the present invention;

FIG. 18 is another two structural diagrams of a fourth-type outgoing synchronization header in a low-latency data transmission method according to the present invention;

FIG. 19 is a schematic diagram of a transmission terminal not receiving a complete incoming synchronization header and sending another fourth-type outgoing synchronization header in a low-latency data transmission method according to the present invention;

FIG. 20 is a schematic diagram of a transmission terminal not receiving a complete incoming synchronization header and sending yet another fourth-type outgoing synchronization header in a low-latency data transmission method according to the present invention.

### Wherein:

1. Transmission terminal
2. Upstream transmission terminal
3. Downstream transmission terminal
4. Incoming synchronization header
5. Outgoing synchronization header

### DETAILED DESCRIPTION OF EMBODIMENTS

The technical solutions in the embodiments of the present invention will be clearly and completely described below with reference to the accompanying drawings. It can be understood that the described embodiments are only part of the embodiments of the present invention, not all of them. Based on the embodiments of the present invention, all other embodiments obtained by those skilled in the art without creative work shall fall within the protection scope of the present invention.

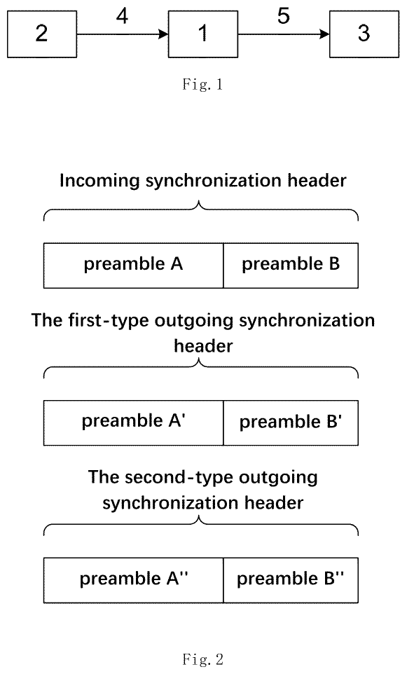

As shown in FIG. 1, in an application embodiment of the present invention, as a low-latency synchronous clock transmission method of the present invention, it is used for a transmission terminal in a transmission system to transmit a synchronous clock with low latency. The transmission system comprises a transmission terminal 1, an upstream transmission terminal 2, and a downstream transmission terminal 3. The upstream transmission terminal 2 is connected to the transmission terminal 1 and sends an incoming synchronization header 4 to the transmission terminal 1. The transmission terminal 1 receives the incoming synchronization header 4. The transmission terminal 1 is connected to the downstream transmission terminal 3 and sends an outgoing synchronization header 5 to the downstream transmission terminal 3. The downstream transmission terminal 3 receives the outgoing synchronization header 5.

The outgoing synchronization header 5 is divided into two types: a first-type outgoing synchronization header and a second-type outgoing synchronization header. The first-type outgoing synchronization header is an outgoing synchronization header sent by the transmission terminal 1 after detecting a complete incoming synchronization header, and the second-type outgoing synchronization header is an outgoing synchronization header sent by the transmission terminal 1 after not detecting a complete incoming synchronization header. The first-type outgoing synchronization header is different from the second-type outgoing synchronization header.

The transmission terminal 1 detecting a complete incoming synchronization header means that the transmission terminal 1 detects both preamble A and preamble B.

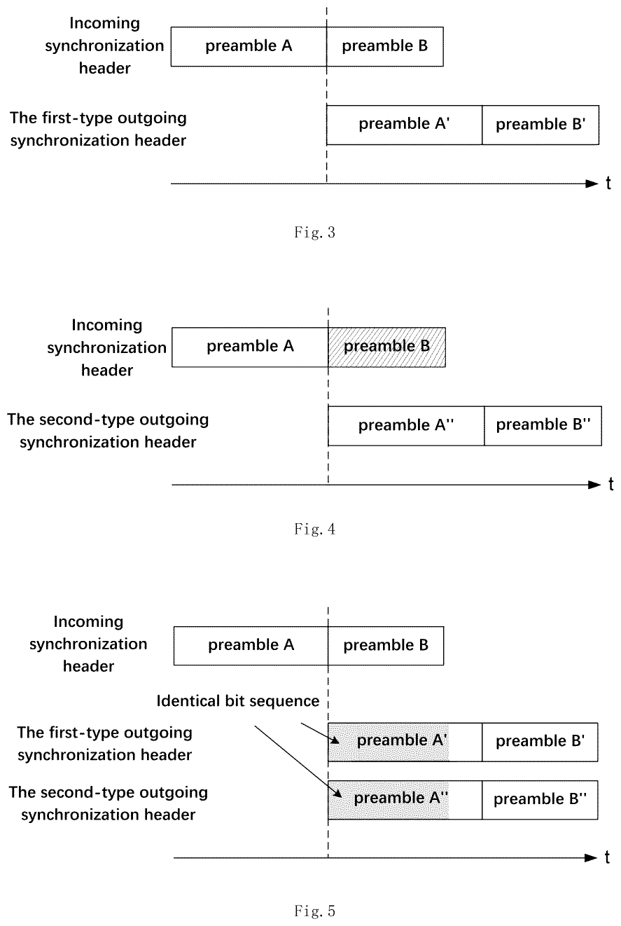

As shown in FIG. 2, in this embodiment, the incoming synchronization header 4 comprises preamble A and preamble B; the first-type outgoing synchronization header comprises preamble A′ and preamble B′, where preamble A and preamble A′ may be the same or different, and preamble B and preamble B′ may be the same or different; the second-type outgoing synchronization header comprises preamble A″ and preamble B″, where preamble A′ is different from preamble A″, or preamble B′ is different from preamble B″, or preamble A′ is different from preamble A″ and preamble B′ is different from preamble B″.

As shown in FIG. 3, in this embodiment, after detecting preamble A of the incoming synchronization header 4, the transmission terminal 1 starts sending preamble A′ of the outgoing synchronization header 5. After detecting preamble A, the transmission terminal 1 continues to detect preamble B. If the transmission terminal 1 detects preamble B, it continues to send preamble B′ after sending preamble A′, and at this time, the outgoing synchronization header 5 sent by the transmission terminal 1 is a first-type outgoing synchronization header.

As shown in FIG. 4, in this embodiment, after detecting preamble A of the incoming synchronization header 4, the transmission terminal 1 starts sending preamble A′ of the outgoing synchronization header 5 (in this embodiment, preamble A′ is the same as preamble A″, which is shown as preamble A″ in FIG. 4). After detecting preamble A, the transmission terminal 1 continues to detect preamble B. If the transmission terminal 1 does not detect preamble B, it continues to send preamble B″ after sending preamble A′ (preamble A″) (in this embodiment, preamble B′ is different from preamble B″), and at this time, the outgoing synchronization header 5 sent by the transmission terminal 1 is a second-type outgoing synchronization header.

Taking a specific synchronization header sequence as an example, in this embodiment, preamble A, preamble A′, and preamble A″ are all the binary sequence 0110101100, preamble B and preamble B′ are the binary sequence 10001110, and preamble B″ is the binary sequence 01110001. If the transmission terminal 1 detects that preamble A of the incoming synchronization header 4 is 0110101100, it starts sending the binary sequence 10001100 of preamble A′ of the outgoing synchronization header 5. After detecting preamble A, the transmission terminal 1 continues to detect preamble B. If the transmission terminal 1 detects that the binary sequence of preamble B is 10001110, it continues to send the binary sequence 10001110 of preamble B′ after sending the binary sequence 0110101100 of preamble A′, and at this time, the outgoing synchronization header sent by the transmission terminal 1 is a first-type outgoing synchronization header; if the transmission terminal 1 does not detect preamble B after detecting preamble A, the outgoing synchronization header sent by the transmission terminal 1 is a second-type outgoing synchronization header, and it continues to send the binary sequence 01110001 of preamble B″ after sending the binary sequence 0110101100 (which is preamble A″ in the second-type outgoing synchronization header).

In the embodiment shown in FIG. 4, preamble A′ is the same as preamble A″. In other embodiments, preamble A′ and preamble A″ may also be different. However, the transmission terminal 1 cannot determine whether to send the first-type outgoing synchronization header or the second-type outgoing synchronization header before completing the detection of preamble B. Therefore, the first several bits of preamble A′ and preamble A″ should be the same, as shown in FIG. 5, where the bit sequences of the shaded parts of preamble A′ and preamble A″ are the same.

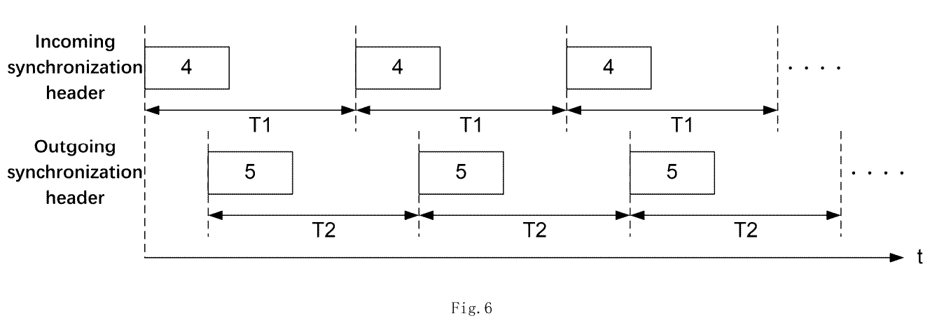

As shown in FIG. 6, in this embodiment, the upstream transmission terminal 2 sends the incoming synchronization header 4 to the transmission terminal 1 at a preset time interval T1. After receiving the incoming synchronization header 4, the transmission terminal 1 uses the position of the incoming synchronization header to perform clock recovery and generate a local clock. The transmission terminal 1 can send the outgoing synchronization header 5 to the downstream transmission terminal 3 at a preset time interval T2 using the generated local clock. To enable the downstream transmission terminal 3 to correctly perform clock recovery and generate a local clock, the outgoing synchronization header 5 is synchronized with the incoming synchronization header 4, that is, the time interval T1 for the upstream transmission terminal 2 to send the incoming synchronization header 4 is the same as the time interval T2 for the transmission terminal 1 to send the outgoing synchronization header 5, i.e., T1=T2.

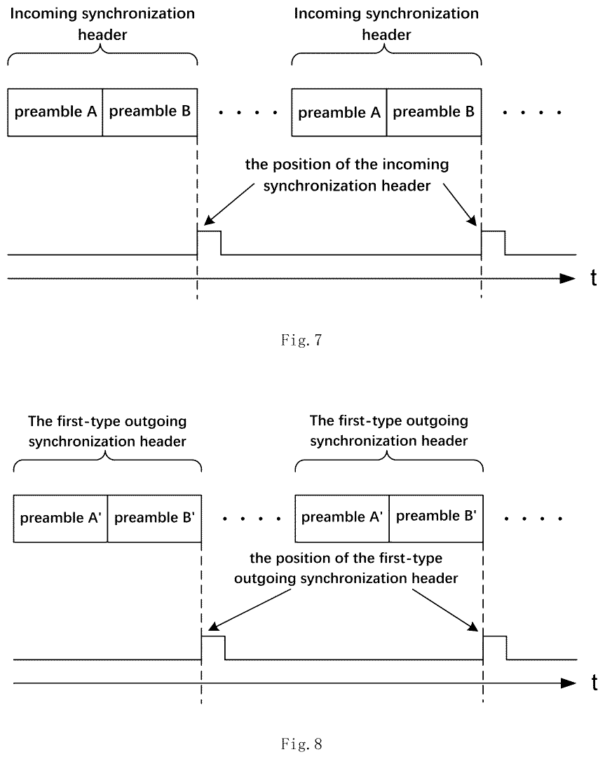

If the transmission terminal 1 detects a complete incoming synchronization header 4 (the transmission terminal 1 detects both preamble A and preamble B), it uses the position of the incoming synchronization header to perform clock recovery and generate a local clock; if the transmission terminal 1 does not detect a complete incoming synchronization header 4 (the transmission terminal 1 fails to detect preamble B after detecting preamble A, or does not detect preamble A), it discards the incoming synchronization header 4. As shown in FIG. 7, the position of the incoming synchronization header refers to the time when the transmission terminal 1 receives and identifies the incoming synchronization header 4. After receiving and identifying the incoming synchronization header 4, incoming synchronization header position information is generated, and this information is sent to a phase-locked loop circuit to recover and generate a local clock signal.

The present invention does not limit the implementation method of the synchronization header receiving circuit, nor does it limit how to use the incoming synchronization header position information to recover the clock. Various means can be used to receive the incoming synchronization header 4. For example, an oversampling receiving circuit can be used, where the oversampling rate is much higher than the transmission rate (generally 3 times or more). After identifying the incoming synchronization header 4, incoming synchronization header position information is generated, and then this information is sent to a phase-locked loop circuit to recover and generate a local clock signal.

Similar to the processing method of the transmission terminal 1 for the detection result of the incoming synchronization header 4, if the downstream transmission terminal 3 detects a complete first-type outgoing synchronization header (the downstream transmission terminal 3 detects both preamble A′ and preamble B′), it uses the position of the first-type outgoing synchronization header to perform clock recovery and generate a local clock; if the downstream transmission terminal 3 does not detect a complete first-type outgoing synchronization header (the downstream transmission terminal 3 fails to detect preamble B′ after detecting preamble A′, or does not detect preamble A′) or detects a second-type outgoing synchronization header, it discards the outgoing synchronization header 5. As shown in FIG. 8, the position of the first-type outgoing synchronization header refers to the time when the downstream transmission terminal 3 receives and identifies the first-type outgoing synchronization header. After receiving and identifying the first-type outgoing synchronization header, synchronization header position information is generated, and this information is sent to a phase-locked loop circuit to recover and generate a local clock signal.

The transmission terminal 1 starts sending the outgoing synchronization header 5 after detecting a part of the incoming synchronization header 4 (preamble A) instead of the complete incoming synchronization header 4, which can effectively reduce the delay from the transmission terminal 1 starting to receive the incoming synchronization header 4 from the upstream transmission terminal 2 to starting to send the outgoing synchronization header 5 to the downstream transmission terminal 3, thereby preventing the delay of the last-level node of the transmission system receiving the synchronization header relative to the first-level node sending the synchronization header from being excessively large. Although the transmission terminal 1 starting to send the outgoing synchronization header 5 after detecting preamble A can reduce the transmission delay of the synchronization header, due to the short bit sequence of preamble A, noise interference on the channel is likely to cause false detection of the synchronization header during the period when no data is transmitted between time slots, or incorrect judgment of the synchronization header position, thereby increasing the false detection rate of the synchronization header. The transmission terminal 1 continuing to detect preamble B after detecting preamble A can prevent this situation and maintain a low false detection rate of the synchronization header.

Applying the embodiment shown in FIG. 1 to a vehicle-mounted audio transmission system, the transmission system uses time-division transmission to transmit audio data. Each time slot transmits one or more audio sampling points, and the system does not transmit data between time slots. No data is transmitted before preamble A in the incoming synchronization header 4. When the transmission terminal 1 detects preamble A, it first generates a signal detection. The time to generate the signal detection is not fixed. Taking a data transmission rate of 100 Mbps as an example, it generally takes 1 to 4 bit times to generate the signal detection. After the signal detection, the binary sequence of preamble A can be detected. The method for the transmission terminal 1 to detect preamble A is: if there exists a continuous N0-bit subsequence SA in preamble A that is the same as a preset N0-bit codeword PA, then the transmission terminal 1 is considered to have detected preamble A, and the end position of the subsequence SA is the end position of preamble A. Preamble B follows preamble A, and the start position of preamble B can be determined according to the end position of preamble A. The method for the transmission terminal 1 to detect preamble B is: if preamble B is the same as a preset codeword PB, then the transmission terminal 1 is considered to have detected preamble B, and the end position of preamble B is the position of the incoming synchronization header.

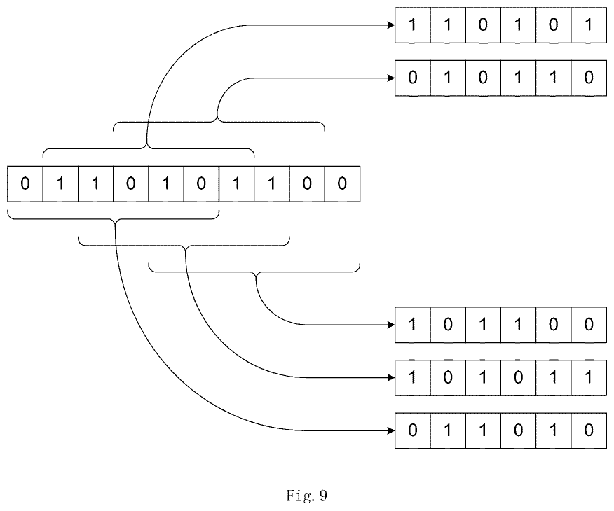

As shown in FIG. 9, in this embodiment, preamble A is the binary sequence 0110101100, N0=6 is taken, the preset 6-bit codeword PA is the binary sequence 101100, and the preset 8-bit codeword PB is the binary sequence 10001110. Continuous 6-bit subsequences are intercepted from preamble A, totaling 5 subsequences: 011010, 110101, 101011, 010110, 101100. Among these 5 subsequences, the 5th subsequence 101100 is the same as the preset codeword PA, so the transmission terminal 1 detects preamble A, and the end position of the subsequence 101100 is the end position of preamble A. After detecting preamble A, the transmission terminal 1 continues to detect preamble B. If the transmission terminal 1 detects the binary sequence 10001110, which is the same as the preset codeword PB, it detects preamble B, and the end position of the binary sequence 10001110 is the position of the incoming synchronization header.

In a vehicle-mounted audio transmission system, due to possible noise interference in the vehicle environment, the synchronization header may have bit errors. To make the transmission system have a certain fault-tolerant performance, in another embodiment, the above methods for the transmission terminal 1 to detect preamble A and preamble B can be adjusted. In this embodiment, the method for the transmission terminal 1 to detect preamble A is: if there exists a continuous N0-bit subsequence SA in preamble A such that the Hamming distance between SA and a preset N0-bit codeword PA is less than a preset value N1, then the transmission terminal detects preamble A; if the Hamming distance between preamble B and a preset codeword PB is less than a preset value N2, then the transmission terminal detects preamble B.

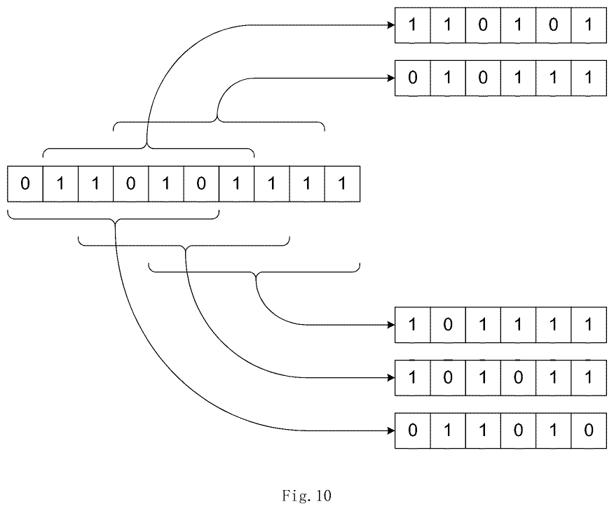

As shown in FIG. 10, in this embodiment, preamble A should be the binary sequence 0110101100, but due to noise interference, the preamble A actually received by the transmission terminal 1 contains 2-bit errors and is the binary sequence 0110101111. N0=6, N1=3, N2=3 are taken, the preset 6-bit codeword PA is the binary sequence 101100, and the preset 8-bit codeword PB is the binary sequence 10001110. Continuous 6-bit subsequences are intercepted from the actually received preamble A, totaling 5 subsequences: 011010, 110101, 101011, 010111, 101111. Among these 5 subsequences, only the 5th subsequence 101111 has a Hamming distance less than 3 (the Hamming distance is 2) from the preset codeword PA, so the transmission terminal 1 detects preamble A, and the end position of the subsequence 101111 is the end position of preamble A. After detecting preamble A, the transmission terminal 1 continues to detect preamble B. If the transmission terminal 1 detects the binary sequence 10010110, which has a Hamming distance less than 3 (the Hamming distance is 2) from the preset codeword PB, it detects preamble B, and the end position of the binary sequence 10010110 is the position of the incoming synchronization header.

In another application embodiment of the present invention, as a low-latency data transmission method of the present invention, it is used for a transmission terminal in a transmission system to transmit data with low latency. The transmission system also adopts the structure shown in FIG. 1, comprising a transmission terminal 1, an upstream transmission terminal 2, and a downstream transmission terminal 3. The upstream transmission terminal 2 is connected to the transmission terminal 1 and sends an incoming synchronization header 4 and a data field following the incoming synchronization header 4 to the transmission terminal 1. The data field is used for transmitting data. The transmission terminal 1 receives the incoming synchronization header 4 and the data field following the incoming synchronization header 4, and places the data received from the data field following the incoming synchronization header 4 into the data field following the outgoing synchronization header 5. The transmission terminal 1 is connected to the downstream transmission terminal 3 and sends the outgoing synchronization header 5 and the data field following the outgoing synchronization header 5 to the downstream transmission terminal 3. The downstream transmission terminal 3 receives the outgoing synchronization header 5 and the data field following the outgoing synchronization header 5.

The outgoing synchronization header 5 is divided into two types: a third-type outgoing synchronization header and a fourth-type outgoing synchronization header. The third-type outgoing synchronization header is an outgoing synchronization header sent by the transmission terminal 1 after detecting a complete incoming synchronization header, and the transmission terminal sends the data field after sending the third-type outgoing synchronization header. The fourth-type outgoing synchronization header is an outgoing synchronization header sent by the transmission terminal 1 after not detecting a complete incoming synchronization header, and the transmission terminal may choose to send the data field or not after sending the fourth-type outgoing synchronization header. The third-type outgoing synchronization header is different from the fourth-type outgoing synchronization header.

The transmission terminal 1 detecting a complete incoming synchronization header means that the transmission terminal 1 detects both preamble C and preamble D.

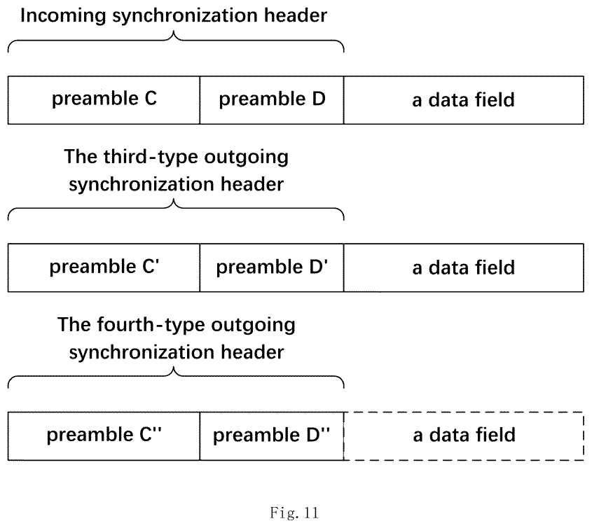

As shown in FIG. 11, in this embodiment, the transmission terminal 1 receives the incoming synchronization header 4 and the data field, and the incoming synchronization header 4 comprises preamble C and preamble D; the transmission terminal 1 sends the third-type outgoing synchronization header and the data field, and the third-type outgoing synchronization header comprises preamble C′ and preamble D′, where preamble C and preamble C′ may be the same or different, and preamble D and preamble D′ may be the same or different; the transmission terminal 1 may also send the fourth-type outgoing synchronization header, and may choose to send the data field or not after sending the fourth-type outgoing synchronization header. The fourth-type outgoing synchronization header comprises preamble C″ and preamble D″, where preamble C′ is different from preamble C″, or preamble D′ is different from preamble D″, or preamble C′ is different from preamble C″ and preamble D′ is different from preamble D″.

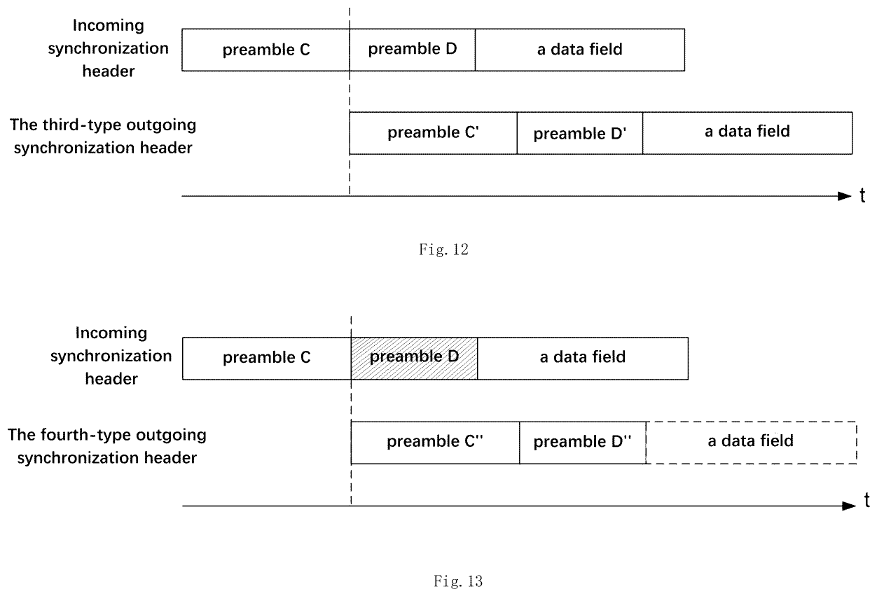

As shown in FIG. 12, in this embodiment, after detecting preamble C of the incoming synchronization header 4, the transmission terminal 1 starts sending preamble C′ of the outgoing synchronization header 5. After detecting preamble C, the transmission terminal 1 continues to detect preamble D. If the transmission terminal 1 detects preamble D, it continues to send preamble D′ after sending preamble C′, and at this time, the outgoing synchronization header 5 sent by the transmission terminal 1 is a third-type outgoing synchronization header. After detecting preamble D, the transmission terminal 1 continues to receive the data field following preamble D, places the data in the data field following preamble D into the data field following preamble D′, and continues to send the data field following preamble D′ after sending preamble D′.

As shown in FIG. 13, in this embodiment, after detecting preamble C of the incoming synchronization header 4, the transmission terminal 1 starts sending preamble C′ of the outgoing synchronization header 5 (in this embodiment, preamble C′ is the same as preamble C″, which is shown as preamble C″ in FIG. 13). After detecting preamble C, the transmission terminal 1 continues to detect preamble D. If the transmission terminal 1 does not detect preamble D, it continues to send preamble D″ after sending preamble C′ (preamble C″) (in this embodiment, preamble D′ is different from preamble D″), and at this time, the outgoing synchronization header 5 sent by the transmission terminal 1 is a fourth-type outgoing synchronization header. After sending preamble D″, the transmission terminal 1 may choose to send the data field or not.

Taking a specific synchronization header sequence as an example, in this embodiment, preamble C, preamble C′, and preamble C″ are all the binary sequence 0110101100, preamble D and preamble D′ are the binary sequence 10001110, and preamble D″ is the binary sequence 01110001. If the transmission terminal 1 detects that preamble C of the incoming synchronization header 4 is 0110101100, it starts sending the binary sequence 10001100 of preamble C′ of the outgoing synchronization header 5. After detecting preamble C, the transmission terminal 1 continues to detect preamble D. If the transmission terminal 1 detects that the binary sequence of preamble D is 10001110, it continues to send the binary sequence 10001110 of preamble D′ after sending the binary sequence 0110101100 of preamble C′, and at this time, the outgoing synchronization header sent by the transmission terminal 1 is a third-type outgoing synchronization header. After detecting the binary sequence 10001110 of preamble D, the transmission terminal 1 continues to receive the data field following preamble D, places the data in the data field following preamble D into the data field following preamble D′, and continues to send the data field following preamble D′ after sending the binary sequence 10001110 of preamble D′; if the transmission terminal 1 does not detect preamble D after detecting preamble C, the outgoing synchronization header sent by the transmission terminal 1 is a fourth-type outgoing synchronization header, and it continues to send the binary sequence 01110001 of preamble D″ after sending the binary sequence 0110101100 (which is preamble C″ in the fourth-type outgoing synchronization header). After sending the binary sequence 01110001 of preamble D″, the transmission terminal 1 may choose to send the data field or not.

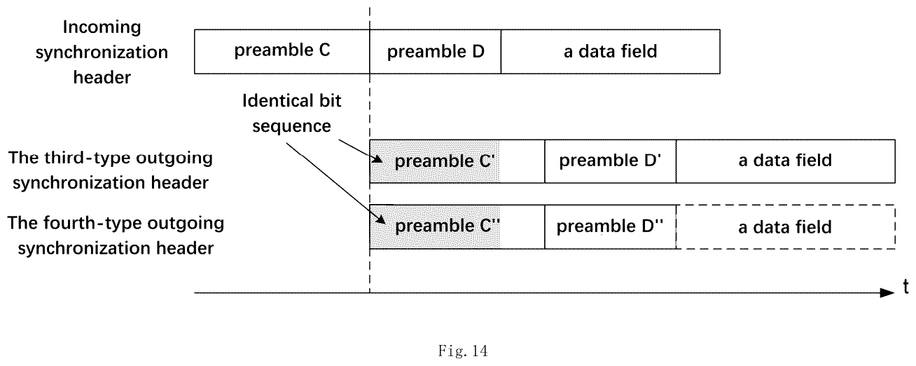

In the embodiment shown in FIG. 13, preamble C′ is the same as preamble C″. In other embodiments, preamble C′ and preamble C″ may also be different. However, the transmission terminal 1 cannot determine whether to send the third-type outgoing synchronization header or the fourth-type outgoing synchronization header before completing the detection of preamble D. Therefore, the first several bits of preamble C′ and preamble C″ should be the same, as shown in FIG. 14, where the bit sequences of the shaded parts of preamble C′ and preamble C″ are the same.

The transmission terminal 1 starts sending the outgoing synchronization header 5 after detecting a part of the incoming synchronization header 4 (preamble C) instead of the complete incoming synchronization header 4, which can effectively reduce the delay from the transmission terminal 1 starting to receive the incoming synchronization header 4 from the upstream transmission terminal 2 to starting to send the outgoing synchronization header 5 to the downstream transmission terminal 3, and at the same time reduce the delay from the transmission terminal 1 starting to receive the data field after the incoming synchronization header 4 to starting to send the data field after the outgoing synchronization header 5, thereby preventing the delay of the last-level node of the transmission system receiving data relative to the first-level node sending data from being excessively large. Although the transmission terminal 1 starting to send the outgoing synchronization header 5 after detecting preamble C can reduce the transmission delay of the synchronization header, due to the short bit sequence of preamble C, noise interference on the channel is likely to cause false detection of the synchronization header during the period when no data is transmitted between time slots, thereby increasing the false detection rate of the synchronization header. The transmission terminal 1 continuing to detect preamble D after detecting preamble C can prevent this situation and maintain a low false detection rate of the synchronization header.

Applying this embodiment to a vehicle-mounted audio transmission system, the transmission system uses time-division transmission to transmit audio data. Each time slot transmits one or more audio sampling points, and the system does not transmit data between time slots. No data is transmitted before preamble C in the incoming synchronization header 4. When the transmission terminal 1 detects preamble C, it first generates a signal detection. The time to generate the signal detection is not fixed. Taking a data transmission rate of 100 Mbps as an example, it generally takes 1 to 4 bit times to generate the signal detection. After the signal detection, the binary sequence of preamble C can be detected. The method for the transmission terminal 1 to detect preamble C is: if there exists a continuous N3-bit subsequence SC in preamble C that is the same as a preset N3-bit codeword PC, then the transmission terminal 1 is considered to have detected preamble C, and the end position of the subsequence SC is the end position of preamble C. Preamble D follows preamble C, and the start position of preamble D can be determined according to the end position of preamble C. The method for the transmission terminal 1 to detect preamble D is: if preamble D is the same as a preset codeword PD, then the transmission terminal 1 is considered to have detected preamble D. The data field follows preamble D, and the start position of the data field can be determined according to the end position of preamble D.

As shown in FIG. 9, in this embodiment, preamble C is the binary sequence 0110101100, N3=6 is taken, the preset 6-bit codeword PC is the binary sequence 101100, and the preset 8-bit codeword PD is the binary sequence 10001110. Continuous 6-bit subsequences are intercepted from preamble C, totaling 5 subsequences: 011010, 110101, 101011, 010110, 101100. Among these 5 subsequences, the 5th subsequence 101100 is the same as the preset codeword PC, so the transmission terminal 1 detects preamble C, and the end position of the subsequence 101100 is the end position of preamble C. After detecting preamble C, the transmission terminal 1 continues to detect preamble D. If the transmission terminal 1 detects the binary sequence 10001110, which is the same as the preset codeword PD, it detects preamble D, and the end position of the binary sequence 10001110 is the start position of the data field.

In a vehicle-mounted audio transmission system, due to possible noise interference in the vehicle environment, the synchronization header may have bit errors. To make the transmission system have a certain fault-tolerant performance, in another embodiment, the above methods for the transmission terminal 1 to detect preamble C and preamble D can be adjusted. In this embodiment, the method for the transmission terminal 1 to detect preamble C is: if there exists a continuous N3-bit subsequence SC in preamble C such that the Hamming distance between SC and a preset N3-bit codeword PC is less than a preset value N4, then the transmission terminal detects preamble C; if the Hamming distance between preamble D and a preset codeword PD is less than a preset value N5, then the transmission terminal detects preamble D.

As shown in FIG. 10, in this embodiment, preamble C should be the binary sequence 0110101100, but due to noise interference, the preamble C actually received by the transmission terminal 1 contains 2-bit errors and is the binary sequence 0110101111. N3=6, N4=3, N5=3 are taken, the preset 6-bit codeword PC is the binary sequence 101100, and the preset 8-bit codeword PD is the binary sequence 10001110. Continuous 6-bit subsequences are intercepted from the actually received preamble C, totaling 5 subsequences: 011010, 110101, 101011, 010111, 101111. Among these 5 subsequences, only the 5th subsequence 101111 has a Hamming distance less than 3 (the Hamming distance is 2) from the preset codeword PC, so the transmission terminal 1 detects preamble C, and the end position of the subsequence 101111 is the end position of preamble C. After detecting preamble C, the transmission terminal 1 continues to detect preamble D. If the transmission terminal 1 detects the binary sequence 10010110, which has a Hamming distance less than 3 (the Hamming distance is 2) from the preset codeword PD, it detects preamble D, and the end position of the binary sequence 10010110 is the start position of the data field.

In the present invention, the first-type outgoing synchronization header is different from the second-type outgoing synchronization header. In the embodiment shown in FIG. 2, the second-type outgoing synchronization header comprises preamble A″ and preamble B″. In other application embodiments, the second-type outgoing synchronization header may also comprise preamble A″ and a part of preamble B″ (not shown in FIG. 2). In other application embodiments, the second-type outgoing synchronization header may also only comprise preamble A″ and not include preamble B″ (or the length of preamble B″ is 0 bits), as shown in FIG. 15(a), or the second-type outgoing synchronization header may only comprise a part of preamble A″, as shown in FIG. 15(b). The first-type outgoing synchronization header being different from the second-type outgoing synchronization header may mean that their lengths are different, or their lengths are equal but their contents are different.

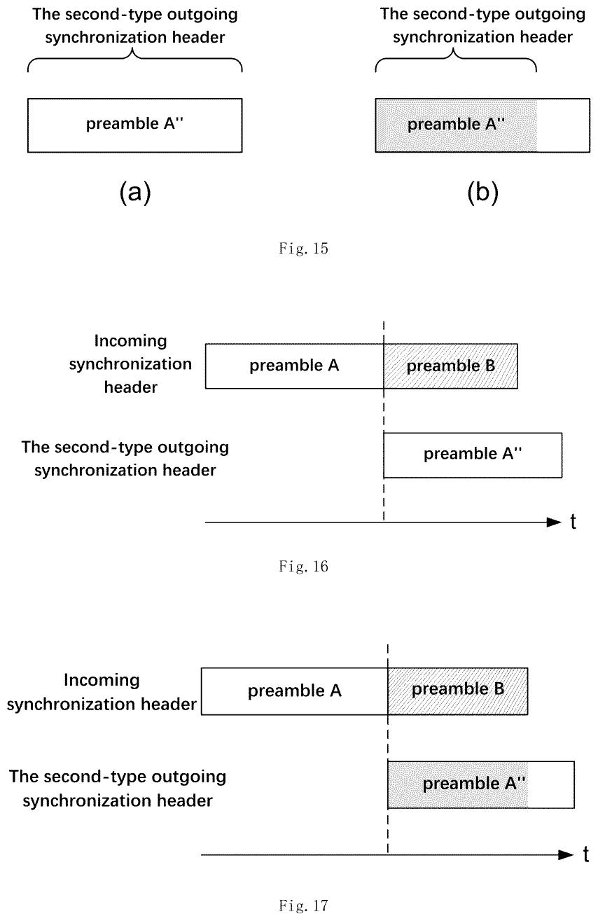

In the embodiment shown in FIG. 16, after detecting preamble A of the incoming synchronization header 4, the transmission terminal 1 starts sending preamble A″ of the outgoing synchronization header 5 (in this embodiment, preamble A′ is the same as preamble A″). After detecting preamble A, the transmission terminal 1 continues to detect preamble B. If the transmission terminal 1 does not detect preamble B, it stops sending after sending preamble A″, and at this time, the outgoing synchronization header 5 sent by the transmission terminal 1 is the second-type outgoing synchronization header in FIG. 15(a). Since the downstream transmission terminal 3 does not detect a complete first-type outgoing synchronization header or detects the second-type outgoing synchronization header in FIG. 15(a), it discards the outgoing synchronization header 5.

In the embodiment shown in FIG. 17, after detecting preamble A of the incoming synchronization header 4, the transmission terminal 1 starts sending preamble A″ of the outgoing synchronization header 5 (in this embodiment, the first several bits of preamble A′ and preamble A″ are the same). After detecting preamble A, the transmission terminal 1 continues to detect preamble B. If the transmission terminal 1 does not detect preamble B, it stops sending after sending the first several bits of preamble A″ (the shaded part of preamble A″ in FIG. 17), and at this time, the outgoing synchronization header 5 sent by the transmission terminal 1 is the second-type outgoing synchronization header in FIG. 15(b). Since the downstream transmission terminal 3 does not detect a complete first-type outgoing synchronization header or detects the second-type outgoing synchronization header in FIG. 15(b), it discards the outgoing synchronization header 5.

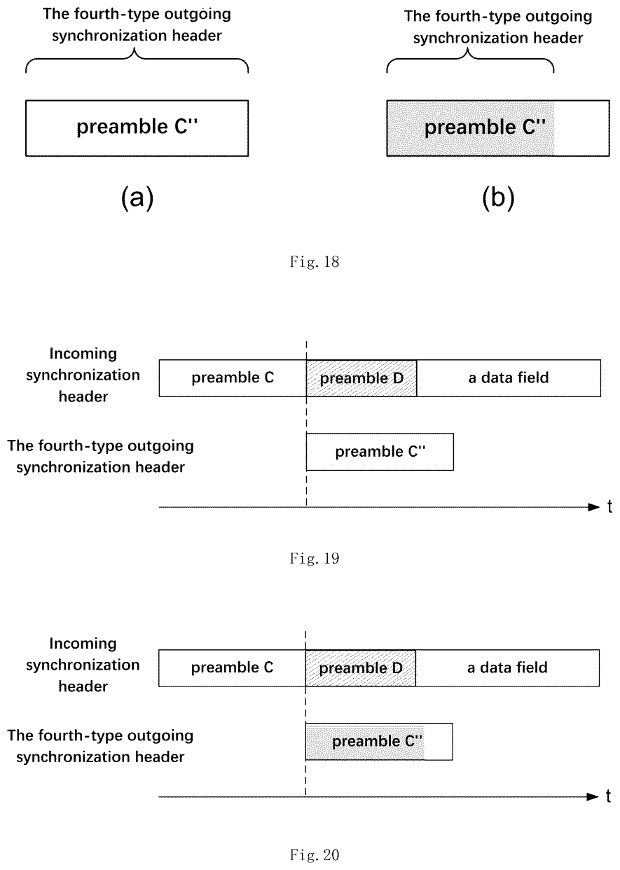

In the present invention, the third-type outgoing synchronization header is different from the fourth-type outgoing synchronization header. In the embodiment shown in FIG. 11, the fourth-type outgoing synchronization header comprises preamble C″ and preamble D″. In other application embodiments, the fourth-type outgoing synchronization header may also comprise preamble C″ and a part of preamble D″ (not shown in FIG. 11). In other application embodiments, the fourth-type outgoing synchronization header may also only comprise preamble C″ and not include preamble D″ (or the length of preamble D″ is 0 bits), as shown in FIG. 18(a), or the fourth-type outgoing synchronization header may only comprise a part of preamble C″, as shown in FIG. 18(b). The third-type outgoing synchronization header being different from the fourth-type outgoing synchronization header may mean that their lengths are different, or their lengths are equal but their contents are different.

In the embodiment shown in FIG. 19, after detecting preamble C of the incoming synchronization header 4, the transmission terminal 1 starts sending preamble C″ of the outgoing synchronization header 5 (in this embodiment, preamble C′ is the same as preamble C″). After detecting preamble C, the transmission terminal 1 continues to detect preamble D. If the transmission terminal 1 does not detect preamble D, it stops sending after sending preamble C″, and at this time, the outgoing synchronization header 5 sent by the transmission terminal 1 is the fourth-type outgoing synchronization header in FIG. 18(a). Since the downstream transmission terminal 3 does not detect a complete third-type outgoing synchronization header or detects the fourth-type outgoing synchronization header in FIG. 18(a), it discards the outgoing synchronization header 5.

In the embodiment shown in FIG. 20, after detecting preamble C of the incoming synchronization header 4, the transmission terminal 1 starts sending preamble C″ of the outgoing synchronization header 5 (in this embodiment, the first several bits of preamble C′ and preamble C″ are the same). After detecting preamble C, the transmission terminal 1 continues to detect preamble D. If the transmission terminal 1 does not detect preamble D, it stops sending after sending the first several bits of preamble C″ (the shaded part of preamble C″ in FIG. 20), and at this time, the outgoing synchronization header 5 sent by the transmission terminal 1 is the fourth-type outgoing synchronization header in FIG. 18(b). Since the downstream transmission terminal 3 does not detect a complete third-type outgoing synchronization header or detects the fourth-type outgoing synchronization header in FIG. 18(b), it discards the outgoing synchronization header 5.

In the application embodiment shown in FIG. 1, the transmission system comprises a transmission terminal 1, an upstream transmission terminal 2, and a downstream transmission terminal 3. In other application embodiments, the transmission system may not include the upstream transmission terminal 2 or the downstream transmission terminal 3.

In this embodiment, the transmission terminal 1 may be implemented in the form of an integrated circuit chip.

The above descriptions are only preferred embodiments of the present invention, but the protection scope of the present invention is not limited thereto. Any person skilled in the art can easily think of changes or substitutions within the technical scope disclosed by the present invention, which should be covered by the protection scope of the present invention.

What is claimed is:

1. A low-latency synchronous clock transmission method, used for a transmission terminal to transmit a synchronous clock with low latency, characterized in that:
the transmission terminal receives an incoming synchronization header;
the incoming synchronization header comprises preamble A and preamble B;
after detecting preamble A, the transmission terminal starts sending an outgoing synchronization header;
after detecting preamble A, the transmission terminal continues to detect preamble B;
if the transmission terminal detects both preamble A and preamble B, the sent outgoing synchronization header is a first-type outgoing synchronization header;
if the transmission terminal detects preamble A but not preamble B, the sent outgoing synchronization header is a second-type outgoing synchronization header;
the first-type outgoing synchronization header is different from the second-type outgoing synchronization header.

2. The low-latency synchronous clock transmission method according to claim 1, characterized in that:
if the transmission terminal detects both preamble A and preamble B, the transmission terminal uses the position of the incoming synchronization header to perform clock recovery and generate a local clock.

3. The low-latency synchronous clock transmission method according to claim 1, characterized in that:
if the transmission terminal fails to detect preamble B after detecting preamble A, the transmission terminal discards the incoming synchronization header.

4. The low-latency synchronous clock transmission method according to claim 1, characterized in that:
if a terminal receiving the outgoing synchronization header receives the first-type outgoing synchronization header, the terminal uses the position of the outgoing synchronization header to perform clock recovery and generate a local clock.

5. The low-latency synchronous clock transmission method according to claim 1, characterized in that:
if a terminal receiving the outgoing synchronization header receives the second-type outgoing synchronization header, the terminal discards the outgoing synchronization header.

6. The low-latency synchronous clock transmission method according to claim 1, characterized in that:
the time interval of the incoming synchronization header is a preset value T1;
the time interval of the outgoing synchronization header is a preset value T2;
T1 is equal to T2.

7. The low-latency synchronous clock transmission method according to claim 2, characterized in that:
the transmission terminal sends the outgoing synchronization header using the generated local clock.

8. The low-latency synchronous clock transmission method according to claim 1, characterized in that:
the method for the transmission terminal to detect preamble A is: if there exists a continuous N0-bit subsequence SA in preamble A such that the Hamming distance between SA and a preset N0-bit codeword PA is less than a preset value N1, then the transmission terminal detects preamble A.

9. The low-latency synchronous clock transmission method according to claim 1, characterized in that:
the method for the transmission terminal to detect preamble B is: if the Hamming distance between preamble B and a preset codeword PB is less than a preset value N2, then the transmission terminal detects preamble B.

10. The low-latency synchronous clock transmission method according to claim 1, characterized in that:
the transmission terminal is implemented as an integrated circuit chip.

11. A low-latency data transmission method, used for a transmission terminal to transmit data with low latency, characterized in that:
the transmission terminal receives an incoming synchronization header and a data field following the incoming synchronization header;
the transmission terminal uses the incoming synchronization header to determine the position of the data field, and the data field is used for transmitting data;
the incoming synchronization header comprises preamble C and preamble D;
after detecting preamble C, the transmission terminal starts sending an outgoing synchronization header;
after detecting preamble C, the transmission terminal continues to detect preamble D;
if the transmission terminal detects both preamble C and preamble D, the sent outgoing synchronization header is a third-type outgoing synchronization header, and the transmission terminal sends the data field after sending the third-type outgoing synchronization header;
if the transmission terminal detects preamble C but not preamble D, the sent outgoing synchronization header is a fourth-type outgoing synchronization header;
the third-type outgoing synchronization header is different from the fourth-type outgoing synchronization header.

12. The low-latency data transmission method according to claim 11, characterized in that:
if the transmission terminal fails to detect preamble D after detecting preamble C, the transmission terminal discards the incoming synchronization header and the data field following the incoming synchronization header.

13. The low-latency data transmission method according to claim 11, characterized in that:
if a terminal receiving the outgoing synchronization header receives the fourth-type outgoing synchronization header, the terminal discards the outgoing synchronization header.

14. The low-latency data transmission method according to claim 11, characterized in that:
the method for the transmission terminal to detect preamble C is: if there exists a continuous N3-bit subsequence SC in preamble C such that the Hamming distance between SC and a preset N3-bit codeword PC is less than a preset value N4, then the transmission terminal detects preamble C.

15. The low-latency data transmission method according to claim 11, characterized in that:
the method for the transmission terminal to detect preamble D is: if the Hamming distance between preamble D and a preset codeword PD is less than a preset value N5, then the transmission terminal detects preamble D.

16. The low-latency data transmission method according to claim 11, characterized in that:
the transmission terminal is implemented as an integrated circuit chip.
